(19) United States
(12) Patent Application Publication
(10) Pub. No.: US 2025/0075088 A1
(43) Pub. Date: Mar. 6, 2025

(54) COFFEE INK

(71) Applicant: Chase Hall, New York, NY (US)

(72) Inventor: Chase Hall, New York, NY (US)

(21) Appl. No.: 18/826,704

(22) Filed: Sep. 6, 2024

Related U.S. Application Data
(60) Provisional application No. 63/536,867, filed on Sep. 6, 2023.

(51) Int. Cl. C09D 11/037

(52) U.S. Cl. CPC C09D 11/037

(57) ABSTRACT

Printing inks and paints including pigments or dyes derived from coffee, and methods for preparing coffee-based inks are disclosed. The coffee-based inks include oil-based and water-based inks, with coffee-derived pigments or dyes. In some embodiments, particulates of roasted and ground coffee beans are incorporated as pigments into carrier fluid such as linseed oil or water. In some embodiments, melanoidins are extracted from coffee beans and incorporated as dyes into a carrier. A variety of formulations and methods are disclosed for preparing coffee-derived inks in various colors. Methods of using coffee-derived inks are also disclosed.

### RELATED APPLICATIONS

This application claims the benefit of U.S. Provisional Application No. 63/536,867, filed on Sep. 6, 2023, which application is incorporated herein by reference in its entirety.

### FIELD OF THE INVENTION

The invention relates to colorant fluids. More specifically, the invention relates to inks, dyes, stains and paints, and the like, that incorporate coffee as a colorant. The invention further relates to methods of making and using such coffee colorant fluids.

### BACKGROUND ART

A variety of printmaking techniques and materials exist for preparing and transferring ink to print media. Various inks, such as typically include a dye or pigment in a gel, sol, or solution, are used to color print media, such as paper, parchment, fabric, or ceramic, and often involve applying the ink to a printing matrix such as wood, linoleum, or metal, with various techniques for preparing the printing matrix to include a design. The ink transferred to the print media then produces a corresponding design on the print media. There is a continued desire for colorant fluids such as inks, dyes, stains, and paints, that provide a variety of tonal and textural attributes, that can be produced efficiently and are environmentally friendly, with suitable conservation qualities, particularly for use in printmaking and related arts.

### BRIEF SUMMARY OF THE INVENTION

Embodiments disclosed herein include printing inks and paints having pigments or dyes derived from coffee. Embodiments disclosed herein include oil-based ink with coffee-derived pigment, oil-based coffee paint, and water-based inks and paints. Embodiments disclosed herein also include processes and methods for preparing such coffee-derived inks.

Some embodiments disclosed herein include methods for preparing inks that include coffee-derived melanoidins. Some embodiments disclosed herein include inks that include coffee-derived melanoidins. Some embodiments disclosed herein include water-based inks that include coffee-derived melanoidin dyes. Some embodiments disclosed herein include inks that include coffee-derived pigments. A variety of formulations and methods are disclosed for preparing coffee-derived inks in various colors. Methods of using coffee-derived inks are also disclosed.

These and various other advantages and features of novelty which characterize the present invention are pointed out with particularity in the claims annexed hereto and forming a part hereof. However, for a better understanding of the invention, its advantages and objects obtained by its use, reference should be made to the drawings which form a further part hereof, and to the accompanying descriptive matter, in which there is illustrated and described preferred embodiments of the present invention.

### BRIEF DESCRIPTION OF THE DRAWINGS

In the drawings, in which corresponding reference numerals and letters indicate corresponding parts of the various embodiments throughout the several views, and in which the various embodiments generally differ only in the manner described and/or shown, but otherwise include parts corresponding to the parts in the other various embodiments;

FIG. 1 is a chart illustrating a method of preparing coffee-based ink, consistent with embodiments disclosed herein.

### DETAILED DESCRIPTION OF THE INVENTION

Embodiments disclosed herein include oil-based and water-based printing inks and paints having pigments derived from coffee. These embodiments include, but are not limited to, oil-based ink with coffee as a pigment, oil-based coffee paint, and coffee-derived dye ink, water-based inks and paints. The use of the terms “ink” and “paint” is not intended to be limiting; rather, inks, dyes, stains, paints, and other characterizations of colorant fluids and mixtures are intended to be included, so far as are consistent with the present disclosure. Herein will generally use the term “ink”, and further use the term “carrier” to mean the fluid or “printmaking medium” to which the coffee-derived pigment is added to prepare the ink.

In some embodiments, a coffee-based ink includes refined linseed oil into which coffee grounds have been mulled. In some embodiments the ink included about 1-1.5 parts refined linseed oil to 2-3 parts coffee beans by volume. In some embodiments the ink further included 0.3 to 0.5 parts calcium carbonate for added body. In some embodiments, linseed oil can be a preferred oil because of its associated drying time. In some aspects of the present disclosure that utilize coffee-based ink for relief and/or intaglio printing application, a slowing drying time can be preferred. In some embodiments, other types of oils can be used in place of linseed oil, such as soy oil.

In some embodiments, the coffee-based ink was printed via an intaglio printing process using copper sheets as a printing matrix, applied with a plastic card into the recessed grooves in the printing matrix, then removed excess ink with a tarlatan until the coffee ink resided only in the recessed grooves, and printed onto cotton paper using an etching press at about 6,000 psi.

In some embodiments, the coffee-based ink was printed via relief printing using a linoleum block as a printing matrix, applied to the matrix using a brayer, and printed onto cotton paper using a hydraulic press at about 60 psi.

We have found that upon transferring the coffee-based ink to the cotton paper, the resulting print showed textural nuances, including a depth to the perceived space of the image.

Upon further experimentation, we discovered various aspects that would affect the resulting coffee-based inks and corresponding prints. Initially, we utilized refined linseed oil because we felt it would be less likely to yellow, and provided slow drying times. In some embodiments, we utilized cold-pressed linseed oil to take advantage of superior wetting capabilities when hand-mulling the coffee pigments to produce the coffee-based ink.

We enhanced the extraction of melanoidins in order to create the greatest range of tones and values in the coffee-based ink and resulting prints by selecting the coffee bean source geography and adjusting the roasting of the coffee beans. In some embodiments, we added about 5 percent by volume of denatured alcohol to the coffee-based ink to speed up extraction of melanoidins from the coffee; this provided more melanoidins in the coffee-based ink, which was desirable for effective printing. The denatured alcohol was allowed to evaporate before printing with the coffee-based inks. In some embodiments, up to around 10 percent by volume of denatured alcohol can be added to the coffee-based ink to speed up extraction of melanoidins from the coffee. Amounts of denatured alcohol exceeding 10 percent by volume can change a consistency of the ink in an undesirable way. For example, amounts of denatured alcohol exceeding 10 percent by volume can compromise a workability of the ink.

The color of the coffee-based ink and the resulting printed images can be chosen by selection of particular roasts of the coffee beans, as well as the geographic region and terroir of the coffee beans. For example, a light roast of Guatemalan coffee beans can be used for inks that produce light colors, and a French roast of Columbian coffee beans can be used for inks that produce dark colors. Other variations of roast and coffee bean origin can be used to produce intermediate-tone inks. The duration of the roast can also be used to adjust the ink color.

We discovered that we could maximize the tonal range in the coffee-based inks by various methods. For example, to achieve the darkest tones, we utilized the darkest roasts. We used the lightest roasts to achieve the lightest tones in the coffee-based inks. In order to better control the tone, we found it advantageous to start with “green” or raw coffee beans so that we could better control the roasting process. In some embodiments, we used dry heat environments and maintained a consistent 190° F., and applied that heat for various times to achieve various tones as desired. For example, for the lightest tones, we applied heat to the raw coffee beans at 190° F. for 3.5 hours in order to remove a sufficient amount of water content to allow the bean to be mulled together with the linseed oil. In another example, for the darkest tones, we applied heat to the raw coffee beans at 190° F. for 8 hours before mulling together with the linseed oil. In some embodiments, we roasted the raw coffee beans in the range of 164-182° F. We have found that roasting the coffee beans at temperatures above about 200° F. can potentially produce acidic properties from constituent(s) of the coffee beans, which is undesirable for stability and archival properties of the ink and resulting prints. In some embodiments, the raw coffee beans can be roasted at a temperature in a range of 356 to 482 degrees Fahrenheit to produce darker colors. However, roasting at this higher temperature range can produce undesirable acidic qualities in the ink. While the acidic properties can negatively affect long-term conservation of the resulting prints or artwork, we have discovered that by adding etching medium such as those including calcium carbonate, which will help to neutralize acids, such concerns can be mitigated. We have also discovered that the carrier constituent(s) such as refined linseed oil, cold-pressed linseed oil, denatured alcohol, calcium carbonate, or combinations thereof, suppressed mold formation with the coffee ink. The carrier essentially surrounded and isolated the pigment particles, greatly reducing exposure of the coffee-derived pigment to humidity, thereby reducing mold formation.

We have discovered that the method of grinding the coffee beans affects the aesthetic qualities of the finished print, as well as the workability of the coffee inks. We found that a very fine grind worked the best. Our initial efforts of hand mulling the coffee beans and carrier were improved by using an industrial coffee grinding machine that would grind the beans as fine as possible, commonly referred to as “Turkish ground”; in some embodiments we utilized equal parts by volume of Turkish ground coffee and carrier. We discovered in further experimentation that adding courser ground coffee to the Turkish ground coffee produced inks with new aesthetic qualities. We produced a range of grind sizes within a given ink by utilizing hand mulling of the roasted coffee produced ourselves from raw coffee beans, and also used the industrial coffee grinding machine to grind store-bought roasted coffee beans to a size commonly referred to as “automatic drip”. We subsequently applied the coffee inks to the printing matrix using a brayer or a plastic card and tarlatan, as described above, and then used a press to print onto cotton paper. In some embodiments, Turkish coffee can have grounds that are sized from 40 to 220 microns. In some embodiments, Turkish ground coffee proved to be the easiest to work with in printing applications. Any coffee bean ground coarser was not ideal in the printing process.

We conducted further experiments by sieving using a 220-micron mesh, by placing about ⅛ cup of coffee-derived ink at the center of a 15 inch by 15 inch square 220-micron mesh, folding the edges of the mesh around the coffee-derived ink, and applying pressure with a palette knife to force the carrier and melanoidins through the mesh, leaving the coffee grounds behind. In some embodiments, the size of the mesh can correspond to a size of the coffee grounds. In an example, as the size of the coffee grounds decreases, a size of the mesh can decrease. For instance, for Turkish ground coffee, a 220-micron mesh can be used. This process produced a coffee-based ink with different aesthetic qualities, and with the workability of traditional printing inks. For example, prints made using the coffee-based ink now had a texture. That texture could be descriptive of what was ultimately trying to be rendered in the image. The textural quality of the ink on the printing matrix made applying gradients to the printing matrixes easier. The grounds functioned somewhat similar to the dot pattern in commercial printing, allowing two inks to be blended in a seamless way.

We conducted still further experiments in which we combined the linseed oils and coffee beans together first, and then exposed them to heat, to develop a process that would maximize the melanoidin extraction. We tested equal parts by volume of whole coffee beans and refined linseed oil, combined in a heat proof jar, and heated the jar in a 190° F. water bath for 8 hours. We prepared equal parts by volume of whole coffee beans and burnt plate oil, combined in a heat proof jar, and heated the jar in a 190° F. water bath for 8 hours. We prepared equal parts by volume of spent coffee grounds and refined linseed oil, combined in a heat proof jar, and heated the jar in a 190° F. water bath for 8 hours. After heating, we placed each mixture on a glass slab, and used a hand muller to join the coffee beans or grounds together with the carrier to produce a coffee ink, mulling until a smooth past-like consistency was obtained. In these experiments, we mulled about ⅛ cup of each coffee ink for about an hour before attempting to make a print using each of the inks. The initial coffee inks were printed using relief printing techniques. We learned the degree to which we mulled the coffee the size of the grit could have certain textural qualities, that ultimately could be used to describe what the image was ultimately trying to render.

In other experiments, we added about 2-5% by volume calcium carbonate and magnesium carbonate as fillers to add body to the coffee-based inks. The added body helped to retain the finer details of the printing matrices when printed onto the cotton paper. In addition, the calcium carbonate helped to mitigate the acidic nature of the coffee beans.

After experimenting with various coffee beans, grind, carrier, additives, fillers, and mixing methods, we tested the various resulting coffee-based inks in various printmaking methods, including relief, etching, collagraph, monotype, and monoprinting techniques. In order to optimize the coffee-based inks for the particular printmaking technique, adding somewhat greater amounts of linseed oil, or adding small amounts of additional calcium carbonate, can be utilized to adjust the properties of the coffee-based ink to better suit the particular printmaking technique, but the basic compositions and methods can be utilized with only minor adjustments. The modification of any given ink is specific to the printing application and the desired outcome. Relief printing applications tend to want stiffer inks, usually this means having a greater quantity of calcium carbonate; whereas intaglio applications want “looser” inks, which means more linseed oil.

We further experimented with creating a water-based version of coffee-based ink that could be used for printmaking or function as paint. We experimented with “cold-brew” methods of extracting the melanoidins from the coffee beans. In some experiments, we placed equal parts by volume Turkish ground coffee and water in a container, and placed in a 40° F. environment for 18 hours, and then strained the grounds. We then prepared a mixture of 1 part glycerin, 2 parts gum arabic, and ¼ part honey. We then prepared a coffee-based ink by mixing 2 parts cold-brewed coffee and 1 part glycerin, gum Arabic (e.g., naturally occurring and synthetic), and honey solution. In some embodiments, the amount of cold brewed coffee can be increased, which can result in a darker colored ink. In order to print using the resulting coffee-based ink, we applied the coffee-based ink to the printing matrix and allowed to dry until the majority of the water evaporated; the water was determined to be appropriately evaporated when the coffee-based ink would stay in place on the printing matrix when the printing matrix was tilted. In this way, the details of the printing matrix and/or the integrity of the artists brush stroke, would be maintained. The melanoidins from the coffee, and the glycerin, gum arabic and honey were left behind when the water evaporated. The glycerin and gum arabic maintained the coffee-based ink in a state of wetness to allow the coffee-based ink to transfer to the cotton paper during printing. We determined that superior results were obtained by evenly dampening the cotton paper about 24 hours prior to printing, and keeping the dampened cotton paper in a sealed container allowed the cotton paper to be evenly relaxed and most receptive to the water-based coffee-based ink. Various dampening methods can be used; for example, misting with an orchid sprayer, applying just enough water to relax the cotton fibers, but not so much water as to leave visible surface water on the cotton paper.

When developing the water-based coffee-based ink, the potential for mold development was a greater concern than with oil-based coffee-based inks we produced. In order to minimize mold development, we dried the cotton paper immediately after printing. In addition, up to about 10% by volume of honey added to the cold-brewed coffee helped to mitigate mold production.

We have developed coffee-based inks with over 26 different tones of brown color, and these inks have been stable for over 2.5 years, maintaining the same color, and without developing sufficient mold or acidity to jeopardize any artwork or paper. We have developed coffee-based inks in the form of thick paste-like gritty mixtures. We have also developed smooth, 220-micron strained coffee-based inks. The paste and smooth inks can each be utilized in a variety of applications, including with various printing and painting techniques and materials. The disclosed compositions, constituents, additives, and methods can be applied to various printing and painting processes, with the disclosed ratios being used for scaling to different production volumes as desired.

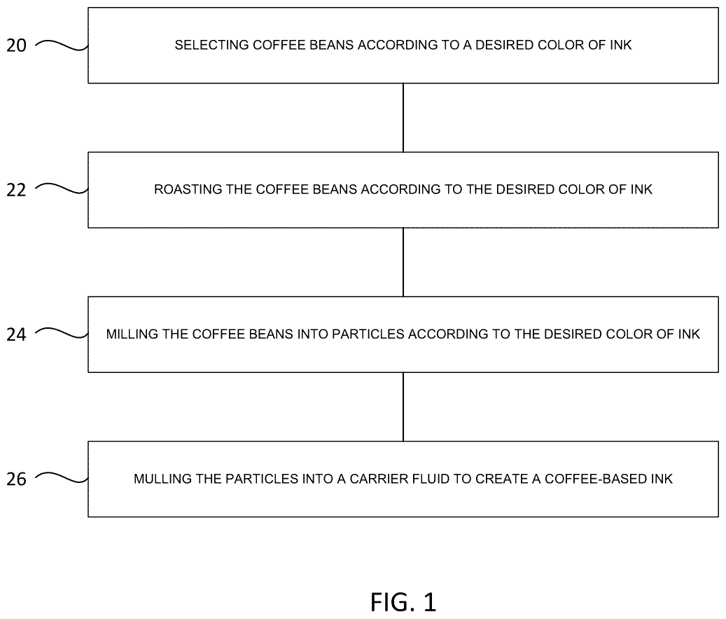

Some embodiments disclosed herein include processes for preparing coffee-based ink such as are illustrated in FIG. 1, which includes the step 20 of selecting coffee beans according to a desired color of ink, 22 roasting the coffee beans according to the desired color of ink, 24 milling the coffee beans into particles according to the desired color of ink, and 26 mulling the particles into a carrier fluid to create a coffee-based ink. As disclosed herein, the color of the coffee-based ink and the resulting printed images can be chosen by selection of the geographic region and terroir of the coffee beans, as well as selection of particular roasts of the coffee beans, as well as the way in which the coffee beans are ground. Further processing steps disclosed herein also affect the color and aesthetic nature of the inks and the resulting prints made from the coffee-based ink, as well as applicability to particular printing techniques and materials.

Various embodiments are described herein of various apparatus, materials, compositions and/or methods. Numerous specific details are set forth to provide a thorough understanding of the overall structure, function, manufacture, and/or use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” “an embodiment,” “an exemplary embodiment,” or the like, means that a particular feature, structure, or characteristic described in connection with the embodiment is included in at least one embodiment. Thus, appearances of the phrases “in various embodiments,” “in some embodiments,” “in one embodiment,” “in an embodiment,” “in an exemplary embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features structures, or characteristics of one or more other embodiments without limitation given that such combination is not illogical or non-functional.

Although at least one embodiment for coffee ink has been described above with a certain degree of particularity, those skilled in the art could make numerous alterations to the disclosed embodiments without departing from the spirit or scope of this disclosure. While the arrangements described in detail herein are preferred, some disclosed elements and methods can be oriented or ordered differently but within the scope of the present disclosure, to the extent that such variations are not illogical or non-functional, and are consistent with the teachings of the present disclosure in view of the art.

One object of the present disclosure is to produce a coffee-based ink or paint suitable for printing or painting. Another object of the present disclosure is to provide methods for producing stable coffee-based ink with desired color and textural properties. Yet another object of the present disclosure is to provide methods of printing with a coffee-based ink. Still another object of the present disclosure is to produce inks from an environmentally friendly and renewable source material.

In some embodiments, the invention includes apparatus and methods for

Exemplary claims include the following:

1. An ink comprising coffee-derived melanoidins and carrier fluid.

2. The ink of claim 1, wherein the coffee-derived melanoidins are extracted from coffee beans into the carrier fluid.

3. The ink of claim 2, further comprising coffee beans milled into particles and mixed with the carrier fluid, and wherein the coffee-derived melanoidins are extracted from particles into the carrier fluid and the particles have been removed from the carrier fluid.

4. The ink of claim 1, wherein the carrier fluid is selected from a group consisting of an oil-based fluid and a water-based fluid.

5. The ink of claim 1, wherein the carrier fluid includes a fluid selected from a group consisting of linseed oil, refined linseed oil, cold-pressed linseed oil, water, denatured alcohol, glycerin, gum arabic, and honey.

6. The ink of claim 1, further comprising an acid-neutralizing additive.

7. The ink of claim 1, further comprising a body-increasing additive.

8. The ink of claim 1, further comprising an additive selected from a group consisting of calcium carbonate and magnesium carbonate.

9. The ink of claim 5, wherein the coffee-derived melanoidins are extracted from ground and roasted coffee beans.

10. The ink of claim 9 wherein the ink includes 1-1.5 parts linseed oil, and 2-3 parts coffee beans by volume.

11. The ink of claim 9 wherein the ink includes 1-1.5 parts linseed oil, 2-3 parts coffee beans by volume, and 0.3-0.5 parts calcium carbonate.

12. The ink of claim 10, wherein the coffee beans are roasted at a temperature in the range of 150-200° F. for a duration in the range of 3 to 10 hours.

13. The ink of claim 12, wherein the coffee beans are roasted at about 190° F. for 3.5 to 8 hours.

14. The ink of claim 9 wherein the ink includes 3.25 parts Turkish ground coffee cold-brewed with 3.25 parts water and strained, and combined with 1 part glycerin, 2 parts gum arabic, and 0.25 parts honey.

15. A process for preparing coffee-based ink comprising the steps of: selecting coffee beans according to a desired color of the ink; roasting the coffee beans according to the desired color of the ink; milling the coffee beans into particles according to the desired color of the ink; and mulling the particles into a carrier fluid to create a coffee-based ink.

16. The process of claim 15, wherein the carrier fluid includes a fluid selected from a group consisting of linseed oil, refined linseed oil, cold-pressed linseed oil, water, denatured alcohol, glycerin, gum arabic, honey, and combinations thereof.

17. The process of claim 15, wherein the step of roasting the coffee beans includes heating the coffee beans at a temperature in the range of 150-200° F. for a duration in the range of 3 to 10 hours.

18. The process of claim 15, wherein the step of roasting the coffee beans includes heating the coffee beans at about 190° F. for 3.5 to 8 hours.

19. The process of claim 16, further including the step of adding an additive selected from a group consisting of calcium carbonate and magnesium carbonate.

20. The process of claim 16, further including the steps of: applying the coffee-based ink to a printing matrix; and selectively transferring the coffee-based ink to print media.

It is to be understood that even though numerous characteristics and advantages of the present invention have been set forth in the foregoing description, together with details of the structure and function of the invention, the disclosure is illustrative only, and changes may be made in detail, especially in matters of shape, size, number, and arrangement of parts within the principles of the invention to the full extent indicated by the broad general meaning of the terms in which the appended claims are expressed. Specific elements herein described with relation to any of the embodiments disclosed herein may be combined or substituted to the extent that such combination or substitution is consistent with the general functioning of the invention and the teachings herein, and as consistent with the appended claims.

What is claimed is:

1. An ink comprising:
coffee-derived melanoidins; and
carrier fluid.

2. The ink of claim 1,
wherein the coffee-derived melanoidins are extracted from coffee beans into the carrier fluid.

3. The ink of claim 2, further comprising coffee beans milled into particles and mixed with the carrier fluid, and wherein the coffee-derived melanoidins are extracted from particles into the carrier fluid and the particles have been removed from the carrier fluid.

4. The ink of claim 1, wherein the carrier fluid is selected from a group consisting of an oil-based fluid and a water-based fluid.

5. The ink of claim 1, wherein the carrier fluid includes a fluid selected from a group consisting of linseed oil, refined linseed oil, cold-pressed linseed oil, water, denatured alcohol, glycerin, gum arabic, and honey.

6. The ink of claim 1, further comprising an acid-neutralizing additive.

7. The ink of claim 1, further comprising a body-increasing additive.

8. The ink of claim 1, further comprising an additive selected from a group consisting of calcium carbonate and magnesium carbonate.

9. The ink of claim 5, wherein the coffee-derived melanoidins are extracted from ground and roasted coffee beans.

10. The ink of claim 9 wherein the ink includes 1-1.5 parts linseed oil, and 2-3 parts coffee beans by volume.

11. The ink of claim 9 wherein the ink includes 1-1.5 parts linseed oil, 2-3 parts coffee beans by volume, and 0.3-0.5 parts calcium carbonate.

12. The ink of claim 10, wherein the coffee beans are roasted at a temperature in the range of 150-200° F. for a duration in the range of 3 to 10 hours.

13. The ink of claim 12, wherein the coffee beans are roasted at about 190° F. for 3.5 to 8 hours.

14. The ink of claim 9 wherein the ink includes 3.25 parts Turkish ground coffee cold-brewed with 3.25 parts water and strained, and combined with 1 part glycerin, 2 parts gum arabic, and 0.25 parts honey.

15. A process for preparing coffee-based ink comprising the steps of:
selecting coffee beans according to a desired color of the ink;
roasting the coffee beans according to the desired color of the ink;
milling the coffee beans into particles according to the desired color of the ink; and
mulling the particles into a carrier fluid to create a coffee-based ink.

16. The process of claim 15, wherein the carrier fluid includes a fluid selected from a group consisting of linseed oil, refined linseed oil, cold-pressed linseed oil, water, denatured alcohol, glycerin, gum arabic, honey, and combinations thereof.

17. The process of claim 15, wherein the step of roasting the coffee beans includes heating the coffee beans at a temperature in the range of 150-200° F. for a duration in the range of 3 to 10 hours.

18. The process of claim 15, wherein the step of roasting the coffee beans includes heating the coffee beans at about 190° F. for 3.5 to 8 hours.

19. The process of claim 16, further including the step of adding an additive selected from a group consisting of calcium carbonate and magnesium carbonate.

20. The process of claim 16, further including the steps of:
applying the coffee-based ink to a printing matrix; and
selectively transferring the coffee-based ink to print media.
